(19) United States
(12) Patent Application Publication
(10) Pub. No.: US 2020/0085121 A1
(43) Pub. Date: Mar. 19, 2020

(54) COMPOSITE MATERIALS AND METHODS OF MANUFACTURE

(71) Applicant: The North Face Apparel Corp., Wilmington, DE (US)

(72) Inventor: Michael Morganti, Castro Valley, CA (US)

(21) Appl. No.: 16/569,971

(22) Filed: Sep. 13, 2019

Related U.S. Application Data
(60) Provisional application No. 62/731,312, filed on Sep. 14, 2018.

(51) Int. Cl. A41D 31/06; D04B 21/16

(52) U.S. Cl. CPC A41D 31/065; B32B 5/026; D04B 21/16

(57) ABSTRACT

A composite material may comprise an inner layer and a knit structure. The inner layer may comprise a mesh material and may be configured to be disposed adjacent a body of a wearer. The knit structure may comprise a warp knit structure. The knit structure may comprise an outer layer. The outer layer may be spaced from the inner layer and disposed to define cavities between the inner layer and the outer layer. The knit structure may comprise spacers. The spacers may be disposed between the inner layer and the outer layer. The spacers may be configured in an alternating pattern with the cavities. Insulators may be disposed in the cavities. The spacers may be configured to control movement of the insulators.

### CROSS-REFERENCE TO RELATED APPLICATIONS

This application is a non-provisional of and claims the benefit to U.S. Provisional Application No. 62/731,312, filed Sep. 14, 2018, which is hereby incorporated by reference in its entirety.

### BACKGROUND

An article of apparel may comprise material comprising an insulator. The insulator may move within the material. For example, the insulator may move as a result of use of the article, movement of a wearer of the article, and/or the force of gravity.

Additionally, the insulator may not be evenly distributed throughout the material. As an example, the insulator may not be evenly distributed throughout the material as a result of the insulator moving within the material. As another example, the insulator may not be evenly distributed throughout the material as a result of the method of manufacturing the material and/or the method of disposing the insulator within the material. Consequently, the article of apparel may have regions of varying thermal insulation.

### SUMMARY

A composite material may comprise a knit structure and an inner layer coupled to the knit structure. The inner layer may be configured to be disposed adjacent to a body of a wearer of an article comprising the composite material. The inner layer may comprise a mesh material. The knit structure may comprise a warp knit structure. The knit structure may comprise an outer layer. The outer layer may be spaced from the first layer and may be disposed to define a plurality of cavities between the outer layer and the inner layer. The knit structure may comprise a plurality of spacers configured in an alternating pattern with the cavities. An insulator may be disposed within the cavities. The spacers may be configured to control movement of the insulators.

### BRIEF DESCRIPTION OF THE DRAWINGS

The following drawings illustrate generally, by way of example, but not by way of limitation, various examples discussed in the present disclosure. In the drawings:

FIG. 1 shows an example composite material.

FIG. 2 shows an example composite material.

FIG. 3 shows an example mesh material.

FIG. 4 shows an example mesh material.

FIG. 5 shows an example warp knit material.

FIG. 6 shows an example portion of a garment.

FIG. 7 shows an example method.

### DETAILED DESCRIPTION

A composite material may comprise an inner layer comprising a mesh material configured to be disposed adjacent a body of a wearer. The composite material may comprise a knit structure. The knit structure may comprise a warp knit structure. The knit structure may comprise an outer layer and a plurality of spacers. The outer layer may be disposed to define a plurality of cavities between the outer layer and the inner layer. The spacers may be disposed between the inner layer and the outer layer. The spacers may be configured in an alternating pattern with the cavities. One or more insulators may be disposed in one or more of the cavities. The inner layer, the outer layer, and/or the spacers may control a movement of the insulators.

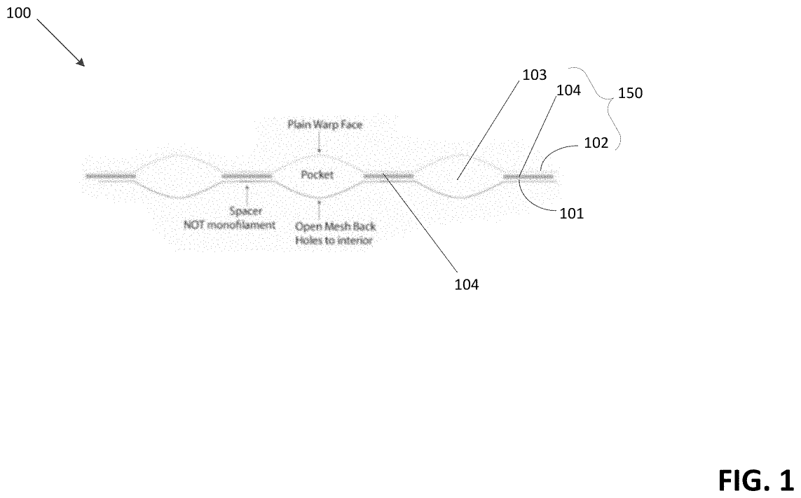

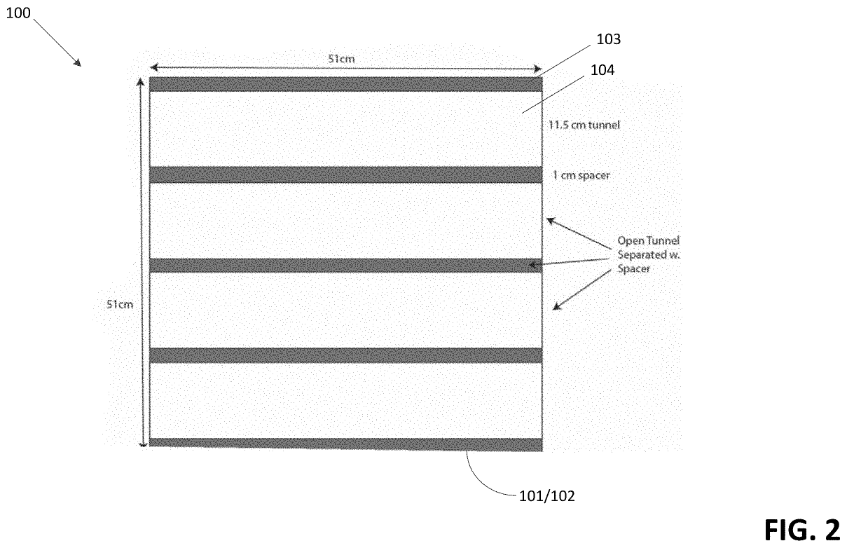

FIGS. 1 and 2 show an example composite material 100. The composite material 100 may comprise an inner layer 101. The inner layer 101 may be configured to be disposed adjacent a body of a wearer of an article comprising the composite material 100. The inner layer 101 may comprise a mesh material. The mesh material may comprise a monofilament material. The mesh material may comprise an open mesh material. The open mesh material may comprise a plurality of holes that pass through one side of the mesh material to another side of the mesh material. The holes may be configured to allow air to pass through the open mesh material. The holes may be configured to allow moisture to pass or evaporate through the open mesh material. The mesh material may comprise a closed mesh material. The closed mesh material may comprise a plurality of holes that pass through at least a portion of the mesh material. At least a portion of the mesh material may cover the holes. If the inner layer 101 comprises more than one layer, such as if there is a pocket or a tunnel, the inner layer 101 may comprise a closed mesh material rather than an open mesh material, based on the technique used to knit or form the inner layer 101. If the inner layer 101 comprises a single layer, the inner layer 101 may comprise an open mesh material, based on the technique used to knit or form the inner layer 101. However, other materials may be used.

The composite material 100 may comprise a knit structure 150. The knit structure 150 may comprise a warp knit material. The warp knit material may be formed using a warp knitting machine. The warp knitting machine may comprise needles, such as in rows along a width of the machine. Each of the needles may be configured to loop its own thread of yarn. The needles may be configured to knit parallel rows of loops simultaneously. The loops may be interlocked in a zig zag pattern. The machine may comprise warp beams. The machine may be configured to feed yarn from warp beams to a row of the needles.

The warp knit material may be formed using a warp knitting technique. The warp knitting technique may comprise knitting yarn in a zigzag pattern following adjacent columns (wales) of the yarn. The number of strands of yarn may equal the number of stitches in a row. Loops of the yarn may interlock vertically along a length of the material.

The knit structure 150 may comprise a raschel knit, a tricot knit, a crocket knit, or a milanese knit. The warp knit material may comprise a synthetic material, such as polyester or polyethylene succinate (PES). The warp knit material may comprise a synthetic material, such as a synthetic microfiber blend (e.g., Primaloft, Thinsulate, Thermolite, or Quallofil). The warp knit material may comprise a natural material, such as cotton or wool. The warp knit material may comprise a blend of materials, such as a blend of synthetic and/or natural materials.

The knit structure 150 may comprise an outer layer 102. The outer layer 102 may be spaced from the inner layer 101. The outer layer 102 may be planar. The outer layer 102 may be substantially flat. For example, the outer layer may have a thickness of less than 1 centimeter (cm), such as a width between 0.1-0.3 cm, 0.4-0.6 cm, 0.7-0.9 cm, as examples.

The knit structure 150 may comprise a plurality of spacers 104. The spacers 104 may extend in a direction orthogonal to a direction of elongation of the outer layer 102. The spacers 104 may be disposed between the outer layer 102 and the inner layer 101. The spacers 104 and the outer layer 102 may comprise a unitary body of knit fiber. Each of the spacers 104 may have the same width. The spacers 104 may have different widths. At least a portion of the spacers may have a width of 1 centimeter (cm), as an example.

The outer layer 102 may be disposed to define at least a portion of a plurality of cavities 103 between the outer layer 102 and the inner layer 101. The spacers 104 may be arranged to define the cavities 103 between the spacers, 104, the inner layer 101, and the outer layer 102. The cavities 103 may have the same dimensions or different dimensions. At least a portion of the cavities may have a width of 11.5 centimeters (cm), as an example. At least a portion of the cavities may have a width of 5 cm, as an example.

The spacers 104 and the cavities 103 may be arranged in an alternating pattern. Each of the cavities 103 may be positioned between two of the spacers 104. The spacers 104 may be evenly-spaced. For example, each of the spacers 104 may be an equal distance away from another spacer 104. Each spacer 104 may be 4-6 centimeters (cm) from another spacer 104, as an example. Each spacer 104 may be 7-9 cm from another spacer 104, as another example. Each spacer 104 may be 10-12 cm from another spacer 104, as another example.

The cavities 103 may be configured to receive material, such as a filler material or structures. The cavities 103 may be configured to receive an insulating material, such as an insulating filler or insulating structures. The insulating structures may comprise insulating tubes, as an example. The insulating material may comprise Primaloft, Thinsulate, or down, as examples.

The composite material 100 may comprise the insulating material. The insulating material may have an insulation value of 0.1-0.8 do, as measured by the ASHRAE-55 standard test. The insulating material may have an R-value of 1.6-2.9 per inch, as defined by ASTM C168. The insulating material may be disposed within the cavities 103. The insulating material may comprise an insulating filler. The insulating material may comprise insulating structures, such as tubes. The insulating material may be inserted through an opening between the inner layer 101 and the outer layer 102. The insulating material may be inserted through an opening between the inner layer 101, the outer layer 102, and at least two of the spacers 504. The opening may be closed, such as with an adhesive, welding, sewing, or knitting. The spacers 104 may be configured to limit movement of the insulating material within the composite material 100.

The composite material 100 may have a weight of between 100-130 grams per square meter (gsm). The composite material 100 may have a weight of between 110-140 gsm. The composite material 100 may have a weight of between 110-130 gsm.

The composite material 100 may be used to manufacture articles. The composite material articles may include articles of apparel, such as jackets, pants, hats, gloves, jumpsuits, or other outerwear. An article of apparel comprising the composite material 100 may be configured such that the inner layer 101 is closer to a body of a user of the article than the outer layer 102 when the article is in normal use.

The composite material articles may include blankets. The composite material articles may comprise sporting equipment or outdoor equipment. The composite material articles may comprise sporting equipment lining, such a lining of a helmet. The inner layer 101, the outer layer 102, the material of the spacers 103, and/or the insulating material may each comprise a material selected based on an article to be manufactured using the composite material 100. For example, materials with physical properties may be suitable for articles for certain activities. The materials may be selected based on desired physical properties of the composite material 100, such as weight, reflectiveness, thickness, color, strength, or flexibility.

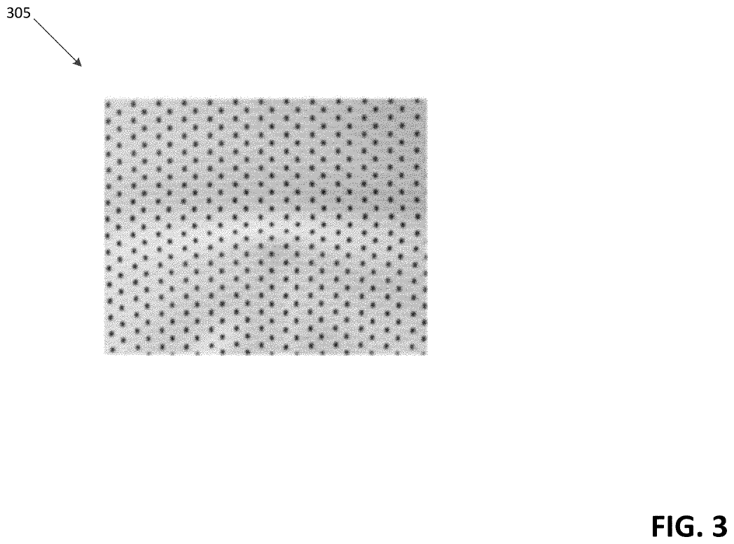

FIG. 3 shows an example open mesh material 305. A material similar to the open mesh material 205 may be used to form the inner layer 101 in FIGS. 1 and 2. The open mesh material 305 may comprise a plurality of holes that pass through one side of the mesh material 305 to another side of the mesh material 305. The holes may be configured to allow air to pass through the open mesh material 305. The holes may be configured to allow moisture to pass or evaporate through the open mesh material.

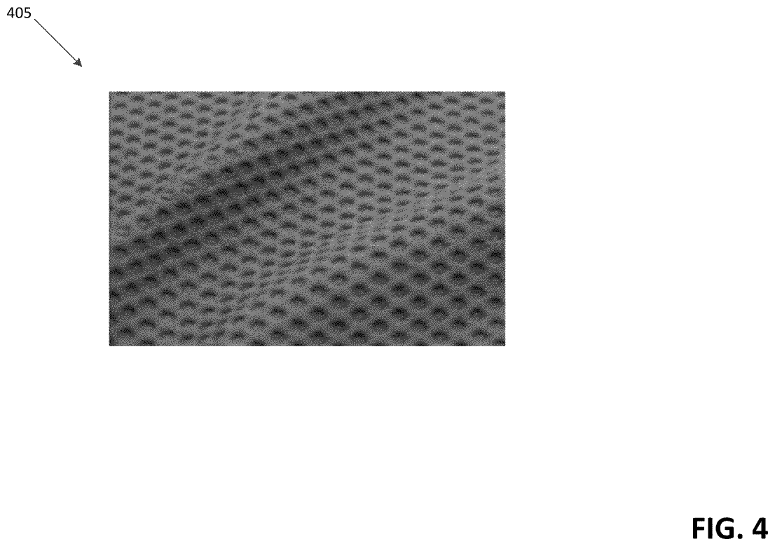

FIG. 4 shows an example closed mesh material 405. A material similar to the closed mesh material 405 may be used to form the inner layer 101 in FIGS. 1 and 2. The closed mesh material 405 may comprise a plurality of holes that pass through at least a portion of the mesh material 405. At least a portion of the mesh material 405 may cover the holes.

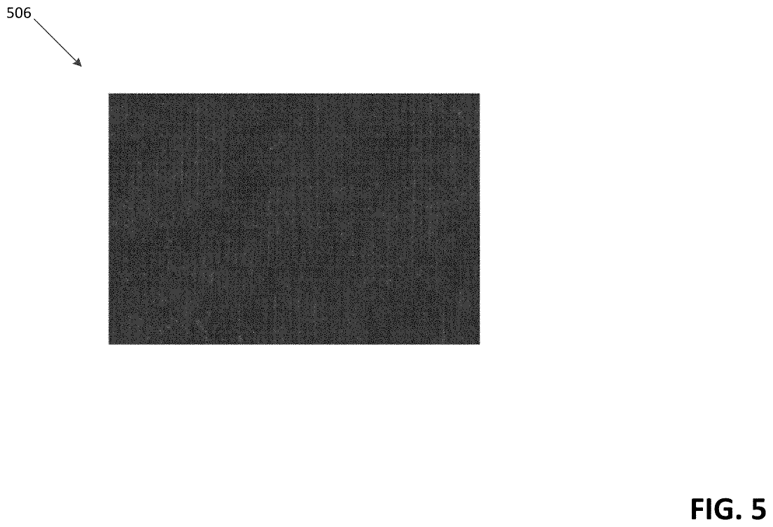

FIG. 5 shows an example warp knit material 506. A material similar to the warp knit material 506 may be used to form the outer layer 102 in FIGS. 1 and 2. The warp knit material 506 may be formed using a warp knitting machine. The warp knitting machine may comprise needles, such as in rows along a width of the machine. Each of the needles may be configured to loop its own thread of yarn. The needles may be configured to knit parallel rows of loops simultaneously. The loops may be interlocked in a zig zag pattern. The machine may comprise warp beams. The machine may be configured to feed yarn from warp beams to a row of the needles.

The warp knit material 506 may be formed using a warp knitting technique. The warp knitting technique may comprise knitting yarn in a zigzag pattern following adjacent columns (wales) of the yarn. The number of strands of yarn may equal the number of stitches in a row. Loops of the yarn may interlock vertically along a length of the material.

The warp knit material 506 may comprise a raschel knit material. The warp knit material 406 may comprise a tricot knit material. The warp knit material 506 may comprise a crocket knit material. The warp knit material 506 may comprise a milanese knit material. The warp knit material 406 may comprise a synthetic material, such as polyester or polyethylene succinate (PES). The warp knit material 506 may comprise a synthetic material, such as a synthetic microfiber blend (e.g., Primaloft, Thinsulate, Thermolite, or Quallofil).

The warp knit material 506 may comprise a natural material, such as cotton or wool. The warp knit material 506 may comprise a blend of materials, such as a blend of synthetic and/or natural materials.

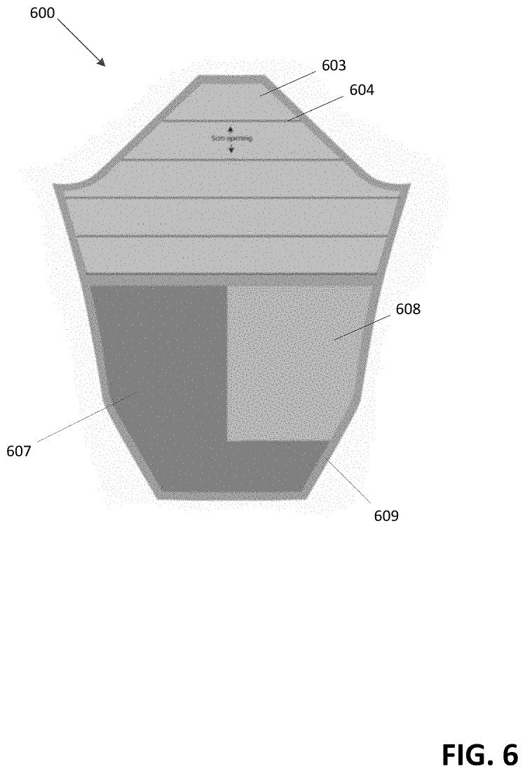

FIG. 6 shows a schematic representation of an example of at least a portion (e.g., panel) of a garment 600. The portion of the garment 600 may comprise a composite material, such as the composite material 100 in FIG. 1. The portion of the garment 600 material may comprise cavities 603. The portion of the garment 600 may comprise a knit structure. The knit structure may comprise an outer layer (e.g., outer layer 102 in FIG. 1) and spacers 604 (e.g, spacers 104 in FIG. 1). The cavities 603 and spacers 604 may be similar to the cavities 103 and spacers 104 in FIG. 1. Although the cavities 603 and the spacers 604 are depicted in FIG. 6 for demonstrative purposes, the cavities 603 and/or the spacers 604 may be between an inner layer and the outer layer of the portion of the garment 600 and may not be observable when viewing the composite material from a top-down perspective. The inner layer and the outer layer of portion of the garment 600 may be similar to the inner layer 101 and the outer layer 102 in FIG. 1.

The portion of the garment 600 may comprise a closed mesh region 607. The closed mesh region 607 may comprise a closed mesh material.

The portion of the garment 600 may comprise an inner layer. The inner layer may comprise a pocket 608. The pocket 608 may be double-layered. The pocket 608 may comprise a synthetic material, such as polyester or PES. The pocket 608 may comprise a natural material, such as cotton. The pocket 608 may comprise a closed mesh material.

The portion of the garment 600 may comprise a border 609. The border 609 may comprise a seam allowance. The seam allowance may couple one or more layers, such as the inner layer and the outer layer. The seam allowance may be sewn. The border 609 may comprise a warp stitch. The border 609 may close the opening of the cavities 603. The border 609 may stitch the inner layer to the outer layer. The border 609 may separate one or more of the cavities 603 and/or the spacers 604 from the closed mesh region 607.

The present disclosure comprises at least the following aspects:

Aspect 1. A composite material comprising: an inner layer comprising a mesh material configured to be disposed adjacent a body of a wearer; a warp knit structure coupled to the inner layer, wherein the warp knit structure comprises: an outer layer spaced from the inner layer and disposed to define at least a portion of a plurality of cavities between the outer layer and the inner layer; and a plurality of spacers disposed between the inner layer and the outer layer and configured in an alternating pattern with the plurality of cavities; and one or more insulators disposed in one or more of the plurality of cavities, wherein one or more of the inner layer, the outer layer, and the spacers control a movement of the one or more insulators.

Aspect 2. The composite material of aspect 1, wherein the plurality of spacers are evenly-spaced.

Aspect 3. The composite material of aspect 1 or any preceding aspect, wherein the alternating pattern comprises each of the plurality of cavities located between at least two of the plurality of spacers.

Aspect 4. The composite material of aspect 1 or any preceding aspect, wherein the mesh material comprises an open mesh material.

Aspect 5. The composite material of aspect 1 or any preceding aspect, wherein the mesh material comprises a closed mesh material.

Aspect 6. The composite material of aspect 1 or any preceding aspect, wherein a plurality of tubes are disposed in the plurality of cavities, wherein the plurality of tubes comprise an insulating material.

Aspect 7. The composite material of aspect 1 or any preceding aspect, wherein an insulating material is disposed within the plurality of cavities.

Aspect 8. The composite material of aspect 1 or any preceding aspect, wherein at least one of the inner layer or the outer layer comprises polyethylene succinate (PES).

Aspect 9. The composite material of aspect 1 or any preceding aspect, wherein the composite material has a weight of between 100-130 grams per square meter.

Aspect 10. The composite material of aspect 1 or any preceding aspect, wherein the composite material has a weight of between 110-140 grams per square meter.

Aspect 11. The composite material of aspect 1 or any preceding aspect, wherein the composite material has a weight of between 110-130 grams per square meter.

Aspect 12. The composite material of aspect 1 or any preceding aspect, wherein the composite material has a weight of 120 grams per square meter.

Aspect 13. The composite material of aspect 1 or any preceding aspect, wherein the plurality of spacers comprise a multi-filament material.

Aspect 14. The composite material of aspect 1 or any preceding aspect, wherein each of the plurality of spacer has a width of 1 centimeter (cm).

Aspect 15. The composite material of aspect 1 or any preceding aspect, wherein each of the plurality of cavities has a width of 11.5 centimeters (cm).

Aspect 16. The composite material of aspect 1 or any preceding aspect, wherein each of the plurality of cavities has a width of 5 centimeters (cm).

Aspect 17. An article of apparel comprising the composite material of aspect 1 or any preceding aspect.

Aspect 18. An article of manufacture comprising the composite material of aspect 1 or any preceding aspect.

Aspect 19. A composite material comprising: a first layer comprising a mesh material; and a knit structure coupled to the first layer, wherein the knit structure comprises: a second layer; and a plurality of spacers distributed between the first layer and the second layer; wherein the first layer, the second layer, and each of the plurality of spacers define a plurality of cavities, each of the plurality of cavities between the first layer, the second layer, and at least two of plurality of spacers.

Aspect 20. The composite material of aspect 19, wherein the plurality of spacers are evenly-distributed.

Aspect 21. The composite material of aspect 19 or any preceding aspect, further comprising an insulating material disposed in at least one of the plurality of cavities.

Aspect 22. The composite material of aspect 19 or any preceding aspect, wherein the plurality of spacers and the plurality of cavities are arranged in an alternating pattern.

Aspect 23. The composite material of aspect 19 or any preceding aspect, wherein the mesh material comprises an open mesh material.

Aspect 24. The composite material of aspect 19 or any preceding aspect, wherein the mesh material comprises a closed mesh material.

Aspect 25. The composite material of aspect 19 or any preceding aspect, wherein a plurality of tubes are disposed in the plurality of cavities, wherein the plurality of tubes comprise an insulating material.

Aspect 26. The composite material of aspect 19 or any preceding aspect, wherein an insulating material is disposed within the plurality of cavities.

Aspect 27. The composite material of aspect 19 or any preceding aspect, wherein at least one of the inner layer or the outer layer comprises polyethylene succinate (PES).

Aspect 28. The composite material of aspect 19 or any preceding aspect, wherein the composite material has a weight of between 100-130 grams per square meter.

Aspect 29. The composite material of aspect 19 or any preceding aspect, wherein the composite material has a weight of between 110-140 grams per square meter.

Aspect 30. The composite material of aspect 19 or any preceding aspect, wherein the composite material has a weight of between 110-130 grams per square meter.

Aspect 31. The composite material of aspect 19 or any preceding aspect, wherein the composite material has a weight of 120 grams per square meter.

Aspect 32. The composite material of aspect 19 or any preceding aspect, wherein the plurality of spacers comprise a multi-filament material.

Aspect 33. The composite material of aspect 19 or any preceding aspect, wherein each of the plurality of spacer has a width of 1 centimeter (cm).

Aspect 34. The composite material of aspect 19 or any preceding aspect, wherein each of the plurality of cavities has a width of 11.5 centimeters (cm).

Aspect 35. The composite material of aspect 19 or any preceding aspect, wherein each of the plurality of cavities has a width of 5 centimeters (cm).

Aspect 36. An article of apparel comprising the composite material of aspect 19 or any preceding aspect.

Aspect 37. An article of manufacture comprising the composite material of aspect 19 or any preceding aspect.

Aspect 38. A method comprising: warp knitting a knit structure comprising a first layer and a plurality of spacers; coupling a second layer comprising a mesh material to the knit structure; and disposing an insulating material between at least two of the plurality of spacers, the first layer, and the second layer.

Aspect 39. The method of aspect 38, wherein the insulating material comprises a plurality of tubes.

Aspect 40. The method of aspect 38 or any preceding aspect, wherein the coupling the plurality of spacers to the first layer comprises affixing the plurality of spacers to the first layer in an evenly-distributed arrangement.

Aspect 41. The method of aspect 38 or any preceding aspect, wherein the coupling the second layer to the knit structure comprises sewing the second layer to the knit structure.

Aspect 42. The method of aspect 38 or any preceding aspect, wherein the coupling the second layer to the knit structure comprises affixing the second layer to the knit structure with at least one of adhesive or welding.

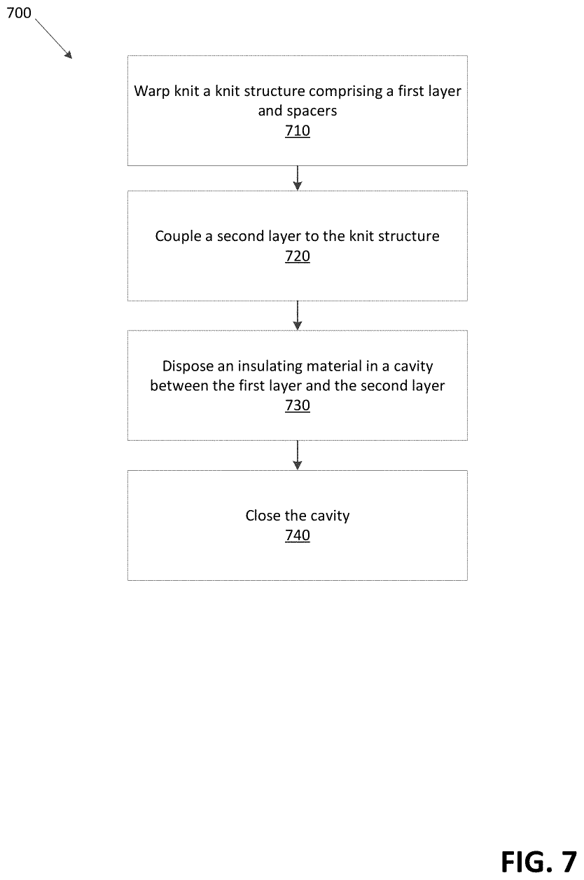

FIG. 7 shows an example method 700. At step 710, a knit structure of a composite material may be warp knit. The composite material may be similar to composite material 100 in FIG. 1, composite material 500 in FIG. 5, and/or composite material 600 in FIG. 6. The spacers may be similar to the spacers 104 in FIG. 1. The knit structure may be similar to the knit structure 150 in FIG. 1. The knit structure may comprise a first layer (e.g., outer layer 102 in FIG. 1). The knit structure may comprise a plurality of spacers (e.g., spacers 104 in FIG. 1).

Warp knitting the knit structure may comprise using a warp knitting machine. The warp knitting machine may comprise needles, such as in rows along a width of the machine. Each of the needles may be configured to loop its own thread of yarn. The needles may be configured to knit parallel rows of loops simultaneously. The loops may be interlocked in a zig zag pattern. The machine may comprise warp beams. The machine may be configured to feed yarn from warp beams to a row of the needles.

The warp may comprise knitting yarn in a zigzag pattern following adjacent columns (wales) of the yarn. The number of strands of yarn may equal the number of stitches in a row. Loops of the yarn may interlock vertically along a length of the material.

At step 720, a second layer of the composite material may be coupled to the knit structure. The second layer may be similar to the inner layer 101 in FIG. 1. The second layer may comprise a mesh material, such as an open mesh material or a closed mesh material. The second layer may be similar to the outer layer 102 in FIG. 1. The second layer may comprise a warp knit material. The second layer may comprise a material different than the first layer.

The second layer may be coupled to the knit structure by an adhesive, such as a glue. The second layer may be coupled to the knit structure by welding. The second layer may be coupled to the knit structure may sewing.

At step 730, an insulating material may be disposed in a cavity between the first layer and the second layer. The cavity may be similar to the cavity 104 in FIG. 1. The insulating material may comprise an insulating filler. The insulating material may comprise insulating structures, such as tubes.

Disposing the insulating material in the cavity may comprise injecting the insulating material in the cavity. Disposing the insulating material in the cavity may comprise inserting the insulating material in the cavity.

At step 740, the cavity may be closed. The insulating material may be inserted through an opening between the inner layer 101, the outer layer 102, and at least two of the spacers 504. The opening may be closed, such as with an adhesive, welding, sewing, or knitting.

1. A composite material comprising:
an inner layer comprising a mesh material configured to be disposed adjacent a body of a wearer;
a warp knit structure coupled to the inner layer, wherein the warp knit structure comprises:
an outer layer spaced from the inner layer and disposed to define at least a portion of a plurality of cavities between the outer layer and the inner layer; and
a plurality of spacers disposed between the inner layer and the outer layer and configured in an alternating pattern with the plurality of cavities; and
one or more insulators disposed in one or more of the plurality of cavities, wherein one or more of the inner layer, the outer layer, and the spacers control a movement of the one or more insulators.

2. The composite material of claim 1, wherein the plurality of spacers are evenly-spaced.

3. The composite material of claim 1, wherein the alternating pattern comprises each of the plurality of cavities located between at least two of the plurality of spacers.

4. The composite material of claim 1, wherein the mesh material comprises an open mesh material.

5. The composite material of claim 1, wherein the mesh material comprises a closed mesh material.

6. The composite material of claim 1, wherein a plurality of tubes are disposed in the plurality of cavities, wherein the plurality of tubes comprise an insulating material.

7. The composite material of claim 1, wherein an insulating material is disposed within the plurality of cavities.

8. The composite material of claim 1, wherein at least one of the inner layer or the outer layer comprises polyethylene succinate (PES).

9. The composite material of claim 1, wherein the composite material has a weight of between 100-130 grams per square meter.

10. The composite material of claim 1, wherein the composite material has a weight of between 110-140 grams per square meter.

11. The composite material of claim 1, wherein the composite material has a weight of between 110-130 grams per square meter.

12. The composite material of claim 1, wherein the composite material has a weight of 120 grams per square meter.

13. The composite material of claim 1, wherein the plurality of spacers comprise a multi-filament material.

14. The composite material of claim 1, wherein one or more of the plurality of spacer has a width of 1 centimeter (cm).

15. The composite material of claim 1, wherein one or more of the plurality of cavities has a width of 11.5 centimeters (cm).

16. The composite material of claim 1, wherein one or more of the plurality of cavities has a width of 5 centimeters (cm).

17. An article of apparel comprising the composite material of claim 1.

18. A composite material comprising:
a first layer comprising a mesh material; and
a knit structure coupled to the first layer, wherein the knit structure comprises:
a second layer; and
a plurality of spacers distributed between the first layer and the second layer;
wherein the first layer, the second layer, and each of the plurality of spacers define a plurality of cavities, each of the plurality of cavities between the first layer, the second layer, and at least two of plurality of spacers.

19. A method comprising:
warp knitting a knit structure comprising a first layer and a plurality of spacers;
coupling a second layer comprising a mesh material to the knit structure; and
disposing an insulating material between at least two of the plurality of spacers, the first layer, and the second layer.

20. The method of claim 19, wherein the coupling the plurality of spacers to the first layer comprises affixing the plurality of spacers to the first layer in an evenly-distributed arrangement.
